(19) United States
(12) Patent Application Publication
(10) Pub. No.: US 2018/0113357 A1
(43) Pub. Date: Apr. 26, 2018

(54) COLOR FILTER SUBSTRATE AND MANUFACTURING METHOD THEREOF, AND DISPLAY DEVICE

(71) Applicants: BOE TECHNOLOGY GROUP CO., LTD., Beijing (CN); CHONGQING BOE OPTOELECTRONICS TECHNOLOGY CO., LTD., Chongqing (CN)

(72) Inventors: Zili HAN, Beijing (CN); Hongjiang WU, Beijing (CN); Jiaqi PANG, Beijing (CN); Changjun ZHA, Beijing (CN); Qiang XIONG, Beijing (CN); Min LI, Beijing (CN)

(21) Appl. No.: 15/788,526

(22) Filed: Oct. 19, 2017

(30) Foreign Application Priority Data
Oct. 20, 2016 (CN) 201610916478.8

(51) Int. Cl. G02F 1/1335; G02B 5/20

(52) U.S. Cl. CPC G02F 1/133514; G02F 1/133512; G02B 5/201

(57) ABSTRACT

The present disclosure provides a color filter substrate and a manufacturing method thereof, and a display device. The color filter substrate comprises a plurality of pixel regions and a matrix provided between every two adjacent pixel regions, the pixel region comprises a color filter layer and the color filter layer and the matrix are partially overlapped. Wherein, a height compensation part is provided above the color filter layer, and a top surface of the height compensation part is configured to be planar so as to compensate for unevenness of a surface of the color filter layer.

### CROSS-REFERENCE TO RELATED APPLICATIONS

The present application claims the priority of Chinese Patent Application No.

201610916478.8, filed on Oct. 20, 2016, the contents of which are incorporated herein in their entirety by reference.

### TECHNICAL FIELD

The present disclosure relates to a field of display technology, and particularly relates to a color filter substrate, a manufacturing method of the color filter substrate, and a display device.

### BACKGROUND

A liquid crystal display device comprises a color filter substrate, an array substrate and a liquid crystal layer provided therebetween. Generally, the color filter substrate comprises a base substrate, a black matrix (BM), a color filter layer (OF, comprising red R, green G and blue B) and a spacer (PS).

A conventional color filter layer has an arc-shaped upper surface, which will affect the display quality, and thus a technical problem to be solved is to provide a color filter substrate with a good flatness.

### SUMMARY

The present disclosure provides a color filter substrate, a manufacturing method of the color filter substrate and a display device, so as to solve at least the problem of poor flatness.

A color filter substrate, comprising a plurality of pixel regions and a matrix provided between every two adjacent pixel regions, the pixel region comprises a color filter layer, and the color filter layer and the matrix are partially overlapped, wherein, a height compensation part is provided above the color filter layer, and a top surface of the height compensation part is configured to be planar so as to compensate for unevenness of a surface of the color filter layer.

Optionally, the color filter substrate further comprises a base substrate, and an area of the height compensation part in the orthographical projection direction relative to the base substrate is smaller than or equal to that of the pixel region.

Optionally, the height compensation part is directly formed on the color filter layer, a bottom of the height compensation part has a shape which is adaptive to that of an upper surface of the color filter layer, and a height of an upper surface of the height compensation part is not larger than a largest height of the color filter layer.

Optionally, the color filter layer has a shape corresponding to a boundary of the pixel region, and the height compensation part has a largest thickness at a center line of the pixel region and has a diminishing thickness from the center line towards two sides.

Optionally, the boundary of the pixel region is rectangular, and the height compensation part has the largest thickness at the center line of the pixel region extending along a long side of the pixel region and has the diminishing thickness from the center line towards two sides.

Optionally, the height compensation height has the largest thickness of 0.1 μm.

Optionally, the color filter substrate further comprises a protection layer formed on the color filter layer, the height compensation part is directly provided on the protection layer, a bottom of the height compensation part has a shape which is adaptive to that of an upper surface of the protection layer, and a height of the upper surface of the height compensation part is not larger than a largest height of the protection layer.

Optionally, the color filter layer has a shape corresponding to a boundary of the pixel region, and the height compensation part has a largest thickness at a center line of the pixel region and has a diminishing thickness from the center line towards two sides.

Optionally, the boundary of the pixel region is rectangular, and the height compensation part has the largest thickness at the center line of the pixel region extending along a long side of the pixel region and has the diminishing thickness from the center line towards two sides.

Optionally, the height compensation height has the largest thickness of 0.5 μm.

Optionally, the color filter substrate further comprises at least one spacer which is provided on the height compensation part, wherein a height of the height compensation part is smaller than that of the spacer, and the height compensation part and the spacer are made of a same material.

Optionally, the height compensation part is made of a transparent material.

Optionally, the transparent material is a resin material.

A manufacturing method of the above color filter substrate comprises steps of forming the black matrix between every two adjacent pixel regions and forming the color filter layer at the pixel region, wherein the manufacturing method of the color filter substrate further comprises a step of forming the height compensation part above the color filter layer such that a top surface of the height compensation part is configured to be planar so as to compensate for unevenness of a surface of the color filter layer.

Optionally, the step of forming the height compensation part above the color filter layer comprises forming the height compensation part directly on the color filter layer such that a bottom of the height compensation part has a shape which is adaptive to an upper surface of the color filter layer and a height of an upper surface of the height compensation part is not larger than a largest height of the color filter layer.

Optionally, the step of forming the height compensation part above the color filter layer comprises forming a protection layer on the color filter layer and forming the height compensation layer on the protection layer such that a bottom of the height compensation part has a shape which is adaptive to an upper surface of the protection layer and a height of an upper surface of the height compensation part is not larger than a largest height of the protection layer.

Optionally, the manufacturing method of the color filter further comprises a step of forming at least one spacer, wherein the height compensation part and the at least one spacer are formed in a single patterning process with a same mask plate, and a part of the mask plate for forming the spacer has a light transmission rate of A %, 0<A<100, a part of the mask plate for forming the height compensation part has a light transmission rate of B %, 0<B<A, and other parts of the mask plate are non-transparent.

Optionally, the part of the mask plate for forming the height compensation part has the light transmission rate of B% at a center line extending along a long side of the pixel region and has a diminishing light transmission rate from the center line towards two sides.

Optionally, the part of the mask plate for forming the height compensation part has the light transmission rate of B (x) %=B % ×k^{x/d}×(1-2x/d)ⁿ, wherein d is a width of a transparent region, x is a distance from a center line of the transparent region, 0≤x<d, and n and k are factors associated with properties of production line and photoresist.

The present disclosure further provides a display device, comprising the above color filter substrate.

### BRIEF DESCRIPTION OF THE DRAWINGS

FIG. 1 is a schematic view of a structure of a color filter substrate in the prior art;

FIG. 2 is a schematic view of a design layout for forming a mask plate including a pattern of spacers in the prior art;

FIG. 3 is a schematic view of a structure of a color filter substrate according to a first embodiment of the present disclosure;

FIG. 4 is a schematic view of a design layout for forming a mask plate including a pattern of spacers according to the first embodiment of the present disclosure;

FIG. 5 is a schematic view of a structure of a color filter substrate according to a second embodiment of the present disclosure; and

FIG. 6 is a flow chart illustrating a manufacturing method of the color filter substrate according to the first embodiment of the present disclosure; and

FIG. 7 is a flow chart illustrating a manufacturing method of the color filter substrate according to the second embodiment of the present disclosure.

### DETAILED DESCRIPTION

In order to make a person skilled in the art better understand the technical solutions of the present disclosure, a color filter substrate, a manufacturing method of the color filter substrate, and a display device according to the present disclosure will be further described in detail in conjunction with the drawings and the embodiments below.

A method for forming a color filter substrate according to the prior art generally comprises the following steps:

first, forming a pattern of a black matrix on a base substrate;

then, forming patterns of color filter layers of three colors by three patterning processes, respectively;

next, forming a protection layer above the black matrix and the color filter layers; and

finally, forming post spacers above the protection layer.

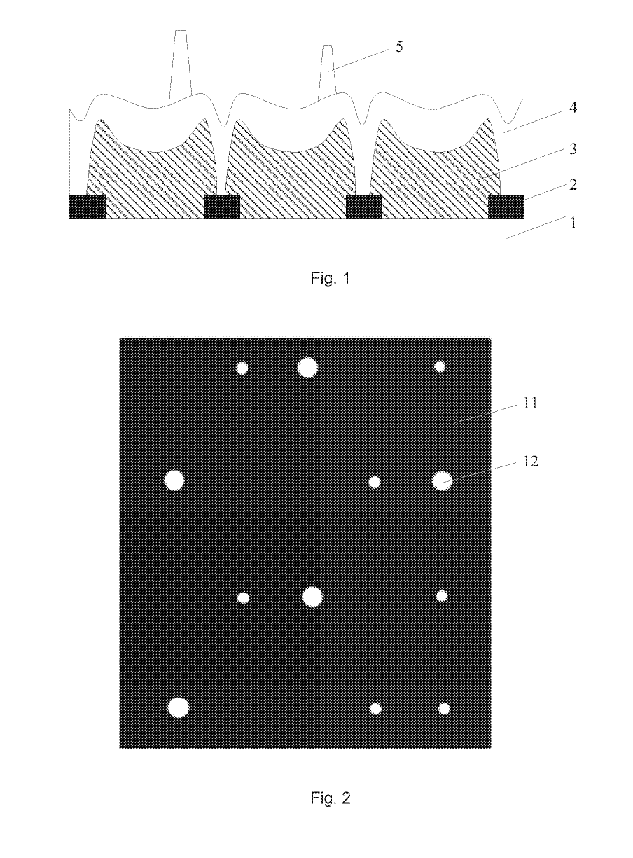

In order to avoid light leakage, the color filter layers and the black matrix are overlapped to a certain extent, and due to fluidity of materials for the color filter layers, after the grid frame formed by the black matrix is filled with the color filter layers, the upper surfaces of the color filter layers are actually arc-shaped, as shown in FIG. 1. The increased segment difference at the overlapping portion between the color filter layers and the black matrix, and the arc-shaped upper surfaces of the color filter layers will affect the image quality. As the size of the liquid crystal display panel is increasing, a part of the color filter layer filled in the grid frame formed by the black matrix is recessed to a larger degree as it is farther away from the grid frame of the black matrix, and thus the segment difference between the central region and the edge of the color filter layer is increased and the radian of the upper surface of the color filter layer is increased, which will make the color filter layer have a most obvious concave at the central region. The obvious concave will make deflection of the corresponding liquid crystal molecules deviate, and affect the image quality of the display product.

The color filter substrate shown in FIG. 1 comprises a base substrate 1, a black matrix 2 and color filter layers 3 formed on the base substrate 1, a protection layer 4 formed on the black matrix 2 and the color filter layers 3, and spacers 5. The protection layer 4 has the function of preventing ions in the color filter layer from being introduced into the liquid crystal layer.

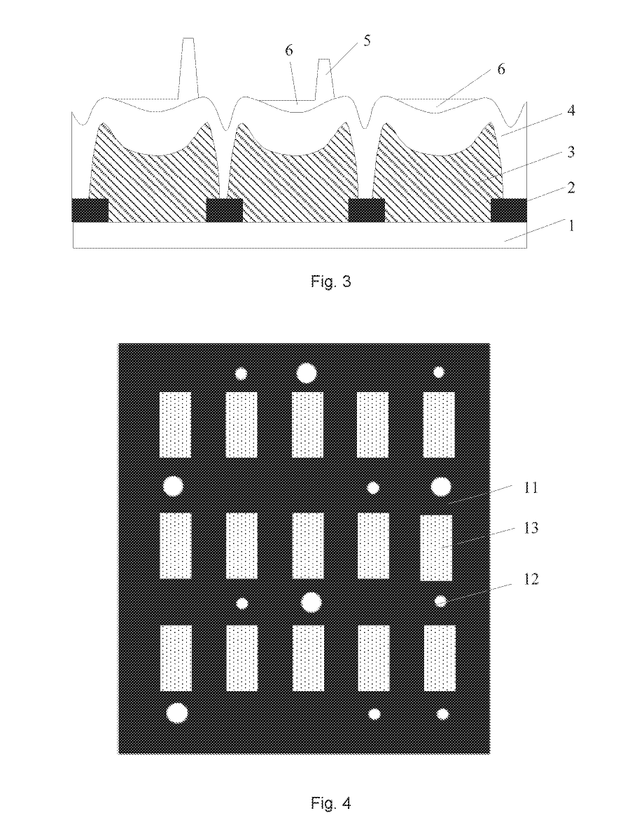

FIG. 2 is a schematic view of a design layout for forming a mask plate including a pattern of the spacers shown in FIG. 1, which illustrates a non-transparent region 11 and a transparent region 12 (the large circle refers to a main spacer, and the small circle refers to a sub-spacer).

### First Embodiment

The present embodiment provides a color filter substrate, which has a good flatness of film surface, and accordingly can increase a display quality of a display device.

The color filter substrate comprises a plurality of pixel regions, and a black light shielding material is provided at a gap between every two adjacent pixel regions to form a black matrix, the central part inside the grid of the black matrix is set to be a pixel transparent region, a color filter layer is provided in the pixel transparent region, and the color filter layer and the black matrix are at least partially overlapped. As shown in FIG. 3, a black matrix 2 is provided above the base substrate 1, the grids surrounded by the black matrix 2 form pixel regions, color filter layers 3 are filled in the pixel regions, and a protection layer 4 is provided above the color filter layer 3 to obtain a better stability, a height compensation part 6 is provided above the protection layer 4, a bottom of the height compensation part 6 has a shape which is adaptive to that of the upper surface of the protection layer 4, the height compensation part 6 has a flat surface at the top, and the height of the upper surface of the height compensation part 6 is not lager than the largest height of the protection layer 4.

Optionally, the height compensation part 6 has an area in the orthographical projection direction which is equal to or smaller than that of the pixel transparent region, that is, the size of the height compensation part is slightly smaller than that of the pixel region. Moreover, the height compensation part 6 should not be too large while performing height compensation, so as to ensure light transmission of the pixel transparent region.

In the color filter substrate according to the present embodiment, the color filter layers 3 and the black matrix 2 are overlapped to a certain extent, and due to fluidity of materials for the color filter layers 3, after the grid frame formed by the black matrix 2 is filled with the color filter layers 3, the upper surfaces of the color filter layers 3 are actually arc-shaped, thus the surface of the formed protection layer 4 is actually also arc-shaped, and the thickness of the height compensation part 6 formed on the protection layer 4 is largest at the center, and is successively decreased towards two sides, therefore, the segment difference between the center and the edge of the color filter layer 3 is effectively eliminated to improve the flatness of film surface of the color filter substrate, and increase the display quality of the display product.

The shape of the color filter layer 3 corresponds to that of the boundary of the pixel region, the thickness of the height compensation part 6 at the center line of the pixel region is largest, and is gradually decreasing from the center line towards two sides.

Optionally, the boundary of the pixel region is rectangular, and the height compensation part 6 has a largest thickness at the center line of the pixel region extending along a long side of the pixel region and has a diminishing thickness from the center line towards two sides. In the present embodiment, the height compensation part 6 has the largest thickness of 0.1 μm, and has the diminishing thickness from the center line towards the two sides.

The height compensation part is made of a transparent material (for example, a resin material) to ensure a normal performance of the color filter substrate.

When the color filter substrate is used to form a display device, there should be a certain distance maintained between the color filter substrate and an array substrate, thus at least one spacer 5 is generally formed on a side of the color filter substrate facing to the array substrate so as to obtain a stable support between the color filter substrate and the array substrate. As shown in FIG. 3, the color filter substrate in the present embodiment further includes a spacer 5, the height of the height compensation part 6 is smaller than that of the spacer 5, and the height compensation part 6 and the spacer 5 are made of a same material. FIG. 3 is a schematic view of the color filter substrate, and the spacer 5 at least comprises a main spacer and a sub-spacer (the main spacer is high, and the sub-spacer is short), both of which are located at the behind of the pixel regions in the column that the color filter layer 3 belongs to.

Correspondingly, the present embodiment further provides a manufacturing method of the color filter substrate. As shown in FIG. 6, the manufacturing method comprises steps of: forming the black matrix 2 at a gap between every two adjacent pixel regions and forming the color filter layers 3 at the pixel transparent regions inside the grids of the black matrix 2; forming the protection layer 4 above the color filter layer 3; forming the height compensation part 6 above the protection layer 4 such that the bottom of the height compensation part 6 has a shape which is adaptive to that of the upper surface of the protection layer 4, the height compensation part 6 has a flat surface at the top, and the height of the upper surface of the height compensation part 6 is not lager than the largest height of the protection layer 4.

The manufacturing method of the color filter substrate according to the present embodiment further comprises forming the spacer 5 in the step of forming the height compensation part 6. Particularly, the height compensation part 6 and the spacer 5 are formed in a single patterning process with a same mask plate. Herein, in the mask plate for preparing the spacer 5, a part of the mask plate for forming the spacer 5 corresponds to a transparent region 12 which has a light transmission rate of A % (0<A<100), for example, the part of the main spacer has a light transmission rate of A₁=100%, and the part of the sub-spacer has a light transmission rate of A₂=20%. In the mask plate for preparing the spacer 5, a part of the mask plate for forming the height compensation part 6 corresponds to a semi-transparent region 13, which has a light transmission rate of B % (O<B<A),for example, the height compensation part 6 has a light transmission rate of B=8%; and other parts of the mask plate correspond to non-transparent regions 11. The part of the mask plate for forming the height compensation part 6 has the light transmission rate of B % at a center line extending along a long side of the pixel region and has a diminishing light transmission rate from the center line towards two sides. Values of A and B could be flexibly set based on the pixel size, the sizes and number of the spacers and the material of the color filter layer and are not limited herein, as long as B<A.

One general calculation formula is in that the part of the mask plate for forming the height compensation part 6 has the light transmission rate of B (x) %=B %×k^{x/d}×(1-2x/d)ⁿ,

Wherein, d is a width of the transparent region, x is a distance from a center line of the transparent region (0≤x<d), and n and k are factors associated with properties of production line and photoresist, for example, illumination density, exposure quantity, and exposure gap of the exposure machine, photoresist viscosity and the like.

FIG. 2 is a schematic view of a design layout for forming a mask plate including a pattern of spacers in the prior art, and FIG. 4 is a schematic view of a design layout for forming a mask plate including a pattern of spacers in the present embodiment. In FIG. 4, the design layout of circles is used for forming the spacers 5 (large circles are used for forming main spacers, and small circles are used for forming sub-spacers) and the design layout of rectangles arranged in an array is used for forming the semi-transparent regions 13 of the height compensation part 6. The design layout of circles has a light transmission rate of A % (0<A<100), and the design layout of rectangles has a light transmission rate smaller than B % (0<B<A) which has a largest light transmission rate at the center line of the rectangular structure, and has a diminishing light transmission rate towards two sides along the given width direction. The light transmission rate is decided based on the characteristics of the display product.

The color filter substrate of the present embodiment can be assembled with an array substrate, and liquid crystal molecules are enclosed between the color filter substrate and the array substrate to form a liquid crystal display panel. The color filter substrate has a better surface flatness, and the spacer 5 can provide uniform and stable support, thus the liquid crystal display panel has a better display effect.

The present embodiment provides the color filter substrate and the manufacturing method thereof, and in light of the segment difference between the central region and the edge of the color filter layer and the arc-shaped surface of the color filter layer, the transparent height compensation part is further provided in the pixel transparent region. The height compensation part can effectively compensate for the segment difference due to the recessed central region of the color filter layer, and facilitate diffusion and deflection of the liquid crystal molecules, and at the same time, the spacers of higher homogeneity can be obtained to further effectively increase the display effect of the display device. Moreover, the height compensation part is formed at the same time as forming the pattern of the post spacer without additional patterning process.

### Second Embodiment

The present embodiment provides a color filter substrate, which has a smaller segment difference between a central region and an edge of a color filter layer in the color filter substrate, and thus the color filter substrate has a better flatness of film surface, and the display quality of a display device including the color filter substrate can be increased accordingly. The difference between the present embodiment and the first embodiment is in that, the color filter substrate in the present embodiment is not provided with the protection layer, and thus the patterning process for forming the protection layer can be eliminated, and the production cost and the operation cost can be decreased.

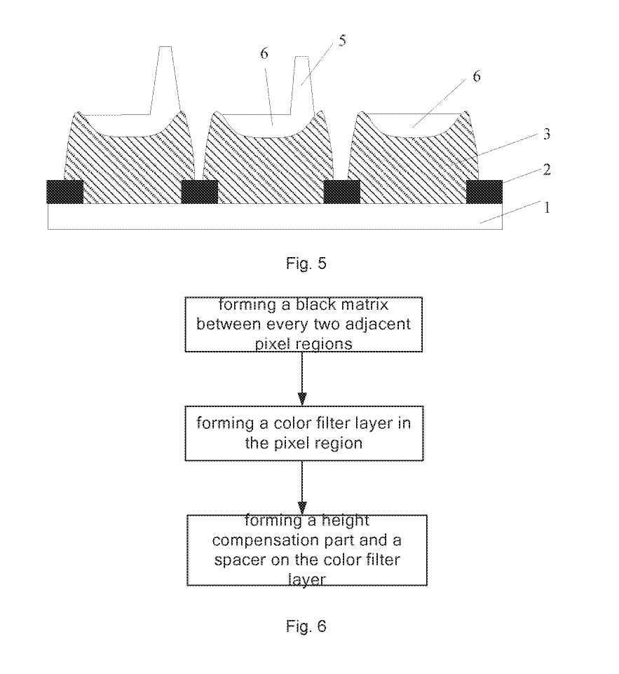

As shown in FIG. 5, a pixel region is filled with a color filter layer 3, a height compensation part 6 is directly provided on the color filter layer 3, a bottom of the height compensation part 6 has a shape which is adaptive to that of the upper surface of the color filter layer 3, the height compensation part 6 has a flat surface at the top, and a spacer 5 is directly provided on the height compensation part 6. The height of the upper surface of the height compensation part 6 is not larger than the largest height of the color filter layer 3. In the structure of the color filter substrate without the protection layer, the largest height of the height compensation part 6 is about 0.5 μm.

The structure of the height compensation part in the present embodiment is similar to that in the first embodiment, and the formula for simultaneously forming the height compensation part and the spacer in the first embodiment is also applicable to that in the present embodiment, which will not be described herein.

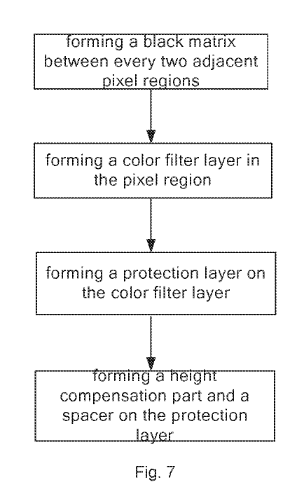

The manufacturing method of the color filter substrate in FIG. 5 shown in FIG. 7 is different from that in FIG. 3 shown in FIG. 6 in that: after forming the color filter layer 3, the height compensation part 6 is directly formed on the color filter layer 3 such that the bottom of the height compensation part 6 has a shape which is adaptive to that of the upper surface of the color filter layer 3, and the height of the upper surface of the height compensation part is not larger than the largest height of the color filter layer.

The first embodiment and the second embodiment provide a color filter substrate and a manufacturing method thereof, and in light of the segment difference between the central region and the edge of the color filter layer and the arc-shaped surface of the color filter layer, the height compensation part is further provided in the pixel transparent region to increase the flatness of the entire surface of the color filter substrate. The transparent height compensation part is defined in each pixel region, the size of the height compensation part is smaller than that of the pixel region, and the height of the height compensation part is smaller than the highest points protruding at two sides of the color filter layer in the pixel region. The height compensation part can effectively compensate for the segment difference due to the recessed central region of the color filter layer, and moreover, the height compensation part is formed at the same time as forming the pattern of the post spacer without additional patterning process.

The height of the height compensation part 6 shown in FIG. 3 does not exceed the largest height of the corresponding protection layer 4, the height of the height compensation part 6 shown in FIG. 5 does not exceed the largest height of the corresponding color filter layer 3, and the present disclosure is not limited thereto. The height of the height compensation part 6 may be larger than the largest height of an element on which the height compensation part 6 is formed, as long as the upper surface of the height compensation part 6 is flat to improve the entire flatness of the resultant color filter substrate and satisfies the performance requirements of the color filter substrate.

### Third Embodiment

The present embodiment provides a display device, which includes the color filter substrate according to the first embodiment or the second embodiment.

The display device may be any product or element having a display function, such as a liquid crystal display panel, electronic paper, a mobile phone, a tablet computer, a television, a display, a laptop computer, a digital photo frame, a navigator, and the like.

Since the display device comprises the above color filter substrate, the display device has a better display effect.

It should be understood that, the above embodiments are only exemplary embodiments for the purpose of explaining the principle of the present disclosure, and the present disclosure is not limited thereto. For one of ordinary skill in the art, various improvements and modifications may be made without departing from the spirit and essence of the present disclosure. These improvements and modifications also fall within the protection scope of the present disclosure,

What is claimed is:

1. A color filter substrate, comprising a plurality of pixel regions and a matrix provided between every two adjacent pixel regions, the pixel region comprises a color filter layer, and the color filter layer and the matrix are partially overlapped, wherein, a height compensation part is provided above the color filter layer, and a top surface of the height compensation part is configured to be planar so as to compensate for unevenness of a surface of the color filter layer.

2. The color filter substrate of claim 1, further comprising s base substrate, wherein an area of the height compensation part in the orthographical projection direction relative to the base substrate is smaller than or equal to that of the pixel region.

3. The color filter substrate of claim 1, wherein the height compensation part is directly formed on the color filter layer, a bottom of the height compensation part has a shape which is adaptive to that of an upper surface of the color filter layer, and a height of an upper surface of the height compensation part is not larger than a largest height of the color filter layer.

4. The color filter substrate of claim 3, wherein the color filter layer has a shape corresponding to a boundary of the pixel region, and the height compensation part has a largest thickness at a center line of the pixel region and has a diminishing thickness from the center line towards two sides.

5. The color filter substrate of claim 4, wherein the boundary of the pixel region is rectangular, and the height compensation part has the largest thickness at the center line of the pixel region extending along a long side of the pixel region and has the diminishing thickness from the center line towards two sides.

6. The color filter substrate of claim 5, wherein the height compensation part has the largest thickness of 0.1 μm.

7. The color filter substrate of claim 1, further comprising a protection layer formed on the color filter layer, the height compensation part is directly provided on the protection layer, a bottom of the height compensation part has a shape which is adaptive to that of an upper surface of the protection layer, and a height of the upper surface of the height compensation part is not larger than a largest height of the protection layer.

8. The color filter substrate of claim 7, wherein the color filter layer has a shape corresponding to a boundary of the pixel region, and the height compensation part has a largest thickness at a center line of the pixel region and has a diminishing thickness from the center line towards two sides.

9. The color filter substrate of claim 8, wherein the boundary of the pixel region is rectangular, and the height compensation part has the largest thickness at the center line of the pixel region extending along a long side of the pixel region and has the diminishing thickness from the center line towards two sides.

10. The color filter substrate of claim 9, wherein the height compensation part has the largest thickness of 0.5 μm.

11. The color filter substrate of claim 1, further comprising at least one spacer which is provided on the height compensation part, wherein a height of the height compensation part is smaller than that of the spacer, and the height compensation part and the spacer are made of a same material.

12. The color filter substrate of claim 1, wherein the height compensation part is made of a transparent material.

13. The color filter substrate of claim 12, wherein the transparent material is a resin material.

14. A manufacturing method of the color filter substrate of claim 1, comprising:
forming the black matrix between every two adjacent pixel regions, and forming the color filter layer at the pixel region, wherein the manufacturing method of the color filter substrate further comprises:
forming the height compensation part above the color filter layer such that the tope surface of the height compensation part is configured to be planar so as to compensate for unevenness of a surface of the color filter layer.

15. The manufacturing method of the color filter layer of claim 14, wherein forming the height compensation part above the color filter layer comprises: forming the height compensation part directly on the color filter layer, such that a bottom of the height compensation part has a shape which is adaptive to an upper surface of the color filter layer, and a height of an upper surface of the height compensation part is not larger than a largest height of the color filter layer.

16. The manufacturing method of the color filter substrate of claim 14, wherein forming the height compensation part above the color filter layer comprises: forming a protection layer on the color filter layer and forming the height compensation layer on the protection layer, such that a bottom of the height compensation part has a shape which is adaptive to an upper surface of the protection layer, and a height of an upper surface of the height compensation part is not larger than a largest height of the protection layer.

17. The manufacturing method of the color filter of claim 14, further comprising:
forming at least one spacer, wherein the height compensation part and the at least one spacer are formed in a single patterning process with a same mask plate, and a part of the mask plate for forming the spacer has a light transmission rate of A %, 0<A <100, and a part of the mask plate for forming the height compensation part has a light transmission rate of B %, 0<B<A, and other parts of the mask plate are non-transparent.

18. The manufacturing method of the color filter substrate of claim 17, wherein the part of the mask plate for forming the height compensation part has the light transmission rate of B% at a center line extending along a long side of the pixel region, and has a diminishing light transmission rate from the center line towards two sides.

19. The manufacturing method of color filter substrate of claim 17, wherein the part of the mask plate for forming the height compensation part has the light transmission rate of B (x) %=B %×k^{x/d}×(1-2x/d)ⁿ, wherein d is a width of a transparent region, x is a distance from a center line of the transparent region, 0≤x<d, and n and k are factors associated with properties of production line and photoresist.

20. A display device, comprising the color filter substrate of claim 1.
